(19) United States
(12) Patent Application Publication
(10) Pub. No.: US 2023/0308860 A1
(43) Pub. Date: Sep. 28, 2023

(54) INTELLIGENT DETECTION OF USER EQUIPMENT USAGE TO IMPROVE USER PACKET SWITCHED DATA EXPERIENCE IN MULTI-SUBSCRIBER IDENTITY MODULE DEVICES

(71) Applicant: QUALCOMM Incorporated, San Diego, CA (US)

(72) Inventors: Harshan VENKATASALAM, Madurai (IN); Durga Prasad, Hyderabad (IN); Ravi Balagani, Hyderabad (IN)

(21) Appl. No.: 17/656,638

(22) Filed: Mar. 25, 2022

(51) Int. Cl. H04W 8/18; H04W 8/22; H04L 43/062; H04L 43/065

(52) U.S. Cl. CPC H04W 8/186; H04W 8/22; H04L 43/062; H04L 43/065

(57) ABSTRACT

In an aspect of the disclosure, a method, a computer-readable medium, and an apparatus for wireless communication of a user equipment (UE) is provided. The apparatus may obtain one or more metrics associated with one or more usage parameters of a subscriber identity module (SIM) of the UE. The apparatus may determine whether the SIM is primarily used for data, based on the one or more metrics. The apparatus may configure the SIM to be data centric based on determining that the SIM is primarily used for data.

### BACKGROUND

### Technical Field

The present disclosure generally relates to communication systems, and more particularly, to autonomous and intelligent detection of user equipment (UE) usage to improve user data experience in multi-subscriber identity module devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may obtain one or more metrics associated with one or more usage parameters of a subscriber identity module (SIM) of the UE The apparatus may determine whether the SIM is primarily used for data, based on the one or more metrics. The apparatus may configure the SIM to be data centric when the SIM is primarily used for data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example network arrangement, in accordance with various aspects of the present disclosure.

FIG. 5 is a flowchart of a method of wireless communication.

FIG. 6 is a flowchart of a method of wireless communication.

FIG. 7 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

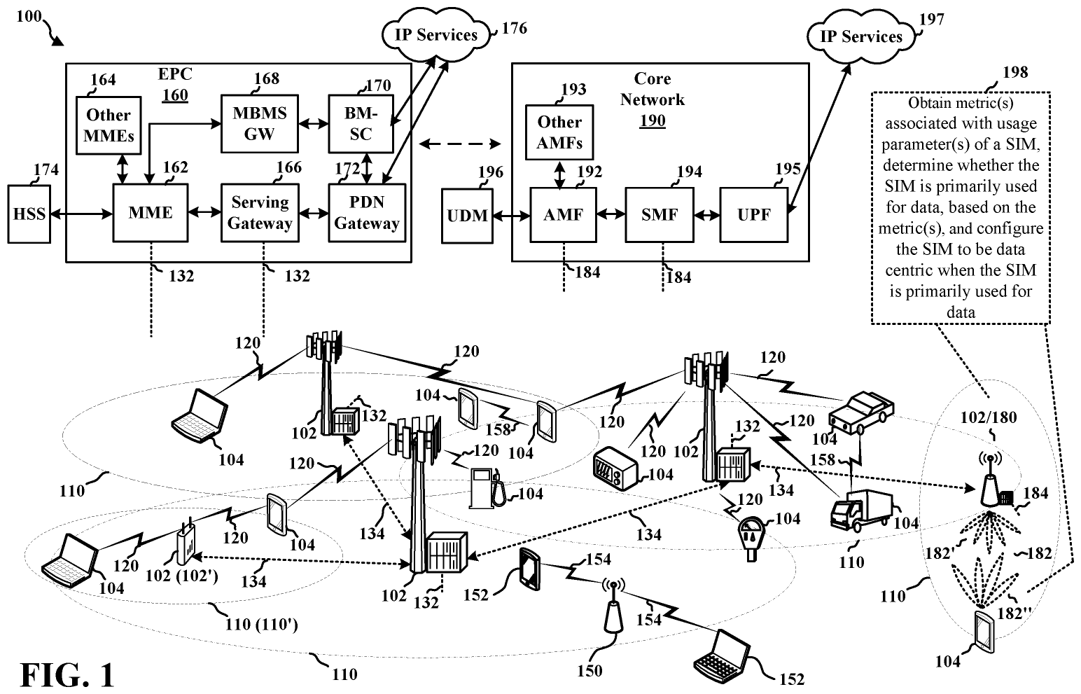

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may be configured to obtain one or more metrics associated with one or more usage parameters of a subscriber identity module (SIM) of the UE, determine whether the SIM is primarily used for data, based on the one or more metrics, and configure the SIM to be data centric when the SIM is primarily used for data (198).

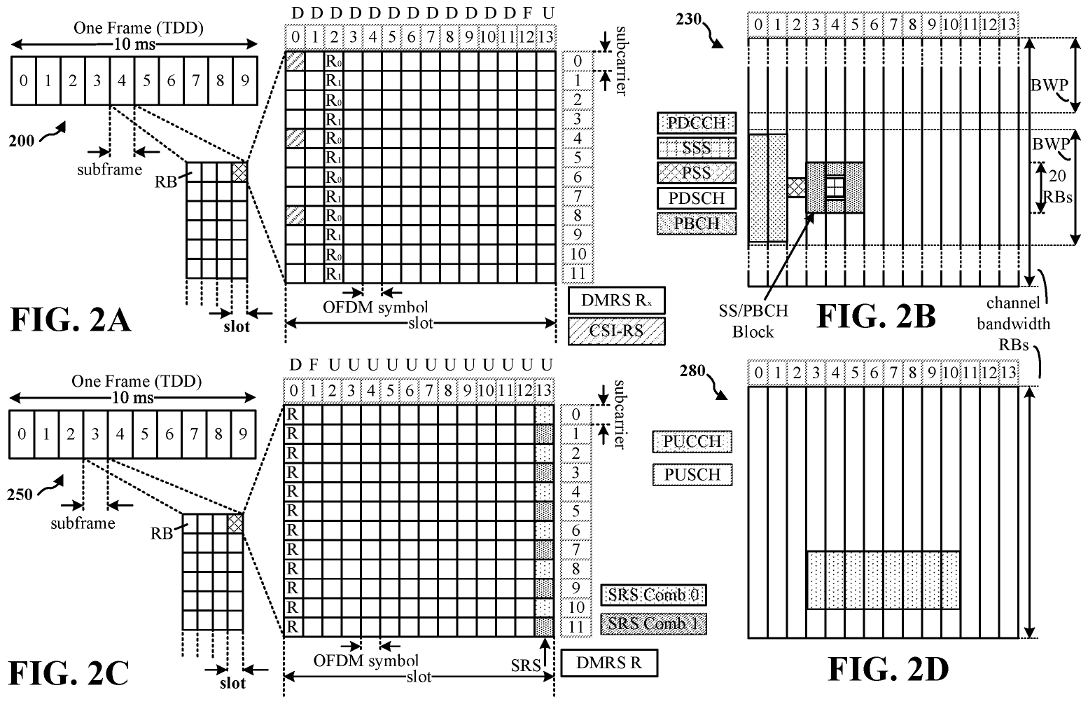

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

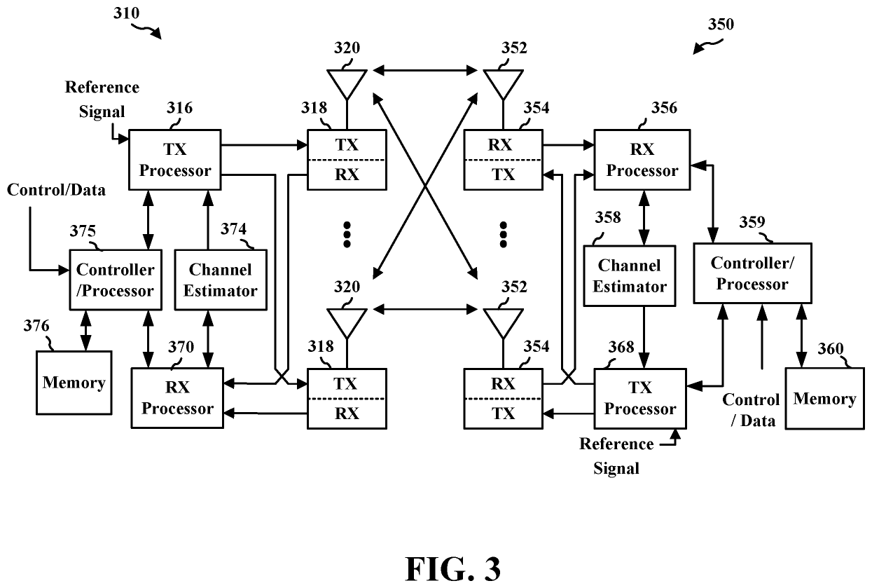

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Existing UEs with multiple SIMs, generally, are configured to prioritize voice services on all of the subscriptions. For example, if a UE is configured with two SIMs, then the subscription for each of the SIM will be configured to prioritize voice services, such as a phone call and the like over other services. If the UE detects an interruption to a voice session, e.g., an IMS registration failure, for any of the SIMs, then the UE may be configured to search for and establish a connection with another RAT that supports voice service. As voice services are prioritized, the UE may not care for the quality of the data service from the selected RAT. For example, the UE may select a RAT with lower data throughput than the previous RAT.

However, if the subscription on which the voice session failed is primarily used for data, then the UE switching to the new RAT with worse data service quality (e.g., lower data throughput) will not improve the user's experience. Instead, it will likely worsen the user's experience because the user will now suffer from poor data service and user's data usage and/or consumption will be disrupted and/or terminated.

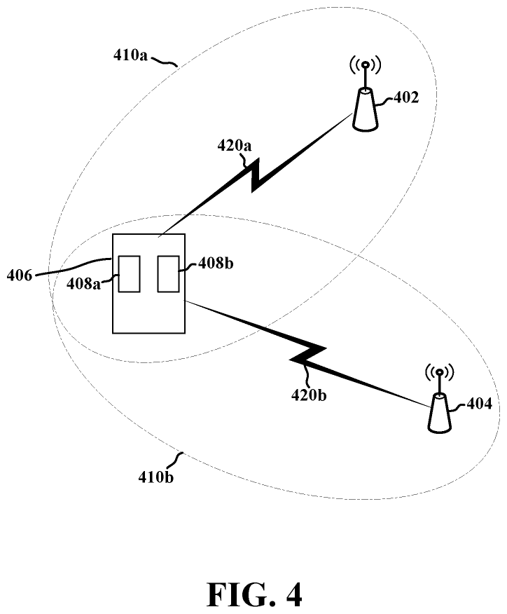

The techniques provided in the present disclosure allows a UE to be configured to intelligently determine whether to switch a subscriber identity module (SIM) to a new RAT when the UE detects a voice session failure of the SIM with a base station. For example, the techniques provided in the present disclosure allow a UE to determine whether a SIM is primarily used for data, configure the SIM as data-centric when it is primarily used for data, and refrain from switching to a new RAT if the UE detects a voice session failure of that SIM with a base station. Accordingly, by refraining to switch to new RATs for data centric SIMs when voice session fails, the techniques described in the present disclosure improve the functionality of the UE by preventing any disruption to the data services provided by the UE to its user (e.g., preventing any disruption to the user's data consumption and/or usage). Additionally, the techniques described in the present disclosure also reduces power consumption by the UE and optimizes UE's power usage since the UE can search for, select, perform voice and/or data session connection procedures with new RATs fewer number of times. Additional details of the techniques described herein are provided with respect to FIGS. 4-7.

FIG. 4 illustrates an example network arrangement where a UE 406 includes two SIMs 408a, 408b. Through each of the SIMs 408a, 408b, the UE 406 may establish connections and/or sessions with the two different base stations 402, 404. For example, as shown in FIG. 4, the UE 406 may establish a connection (e.g., communication link 420a) with the base station 402 using the SIM 408a, and similarly, the UE 406 may establish a connection (e.g., communication link 420b) with the base station 404 using the SIM 408b.

In some implementations, the UE 406 may establish a voice session and a data session with the base station 402 using the SIM 408a. In some implementations, the UE 406 may establish a voice session and/or a data session with the base station 404 using the SIM 408b. The UE 406 may be configured to provide data services (e.g., streaming video, gaming, and the like) using a SIM designated or selected by the user as a default data subscription (DDS) SIM. For example, the user may select the SIM 408a as a DDS SIM, and the UE 406 may provide data services to the user using SIM 408a (e.g., via the data session established with the base station 402).

The UE 406 may be configured to determine, autonomously, whether one or more SIMs (e.g., SIM 408a, SIM 408b) of the UE 406 are being primarily used for data. As described herein, a SIM is primarily used for data if one or more metrics of one or more usage parameters satisfy certain threshold metrics (e.g., predetermined threshold metrics). Examples of the one or more usage parameters may include, but are not limited to, whether a SIM is selected and/or designated (e.g., by a user) as a DDS SIM, a length of time a SIM has be selected and/or designated as a DDS SIM, amount of data usage per one or more time periods (e.g., per hour, per week, per day, and the like) via that SIM, the amount of time since the last voice and/or emergency call made using that SIM, and the like.

The UE 406 may obtain metric(s) for one or more of the usage parameters. Examples of metric(s) for the one or more usage parameters may include, but are not limited to, For example, a processor of the UE 406 (e.g., a processor of a modem of UE 406) may be configured to determine whether a user has selected a SIM as a DDS SIM, Similarly, the processor of the UE 406 may be configured to monitor and/or collect data related to when the last voice and/or emergency call was made using the SIM, amount of data usage per a time period via that SIM, the length of time a SIM has been selected and/or designated as a DDS SIM, and the like.

The UE 406 may be configured to determine whether the obtained metrics of the parameters of a SIM (e.g., SIM 408a, 408b) satisfy corresponding threshold values of the usage parameters. The UE 406 may determine that a SIM is primarily used for data when the obtained metrics of the SIM satisfy one or more corresponding threshold values of the usage parameters. In some implementations, one or more usage parameters may be prioritized (e.g., weighed more heavily) than other usage parameters, and the UE 406 may determine that a SIM is primarily used for data when the obtained metrics for one or more of the prioritized usage parameters satisfy the corresponding threshold values.

The UE 406 may configure a SIM as a data-centric SIM when a SIM is determined as primarily used for data. Continuing with the above provided example, if SIM 408a is determined to be primarily used for data by the UE 406, then the UE 406 (e.g., a processor of UE 406) may configure the SIM 408a as a data-centric SIM. In some implementations, a UE may configure a SIM as a data-centric SIM by designating the SIM as a data-centric SIM or turning on a setting within the UE that indicates to a processor of the UE that the SIM is configured and/or designated as a data-centric SIM.

The UE 406 may be configured to refrain from switching to a new RAT if the UE 406 detects a voice session failure, e.g., IMS registration failure, on a SIM configured and/or designated as data-centric. For example, if the UE 406 configures and/or designates the SIM 408a as a data-centric SIM, then the UE 406 may refrain from switching from base station 402 even if the UE 406 detects that a voice session of SIM 408a with the base station has failed (e.g., IMS registration failure).

In some implementations, the UE 406 may be configured to allow a user to provide an input to the UE 406 indicating which, if any of the SIMs 408a, 408b, may be configured and/or designated as a data-centric SIM. For example, the UE 406, may provide a user interface to a user to receive an input from the user that indicates which of the SIMs of the UE 406 may be configured and/or designated as a data-centric UE. For example, the user may provide an input to the UE 406 via the user interface, where the input indicates that the SIM 408a is selected by the user as a data-centric SIM. In some implementations, in response to receiving the input, the UE 406 may configure and/or designate the SIM 408a as a data-centric SIM. In some implementations, the UE 406, based on the user input, may configure and/or designate a SIM (e.g., SIM 408a, 408b) as a data-centric SIM prior to the UE 406 obtaining sufficient metrics of the one or more usage parameters to determine whether the SIM can be configured and/or designated as a data-centric SIM.

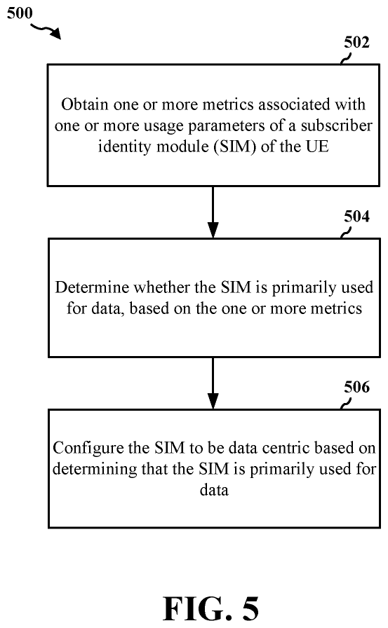

FIG. 5 is a flowchart 500 of a method of wireless communication. The method may be performed by a UE (e.g., the UE 104; the UE 406; the apparatus 702). At 502, the UE may obtain one or more metrics or values associated with one or more usage parameters of a SIM of the UE. As described above, examples of the one or more usage parameters may include, but are not limited to, whether a SIM is selected and/or designated by the user as a DDS SIM, a length of time a SIM has been selected and/or designated as a DDS SIM, amount of data usage per one or more time periods (e.g., per hour, per week, per day, and the like) via that SIM, the amount of time since the last voice and/or emergency call made using that SIM, and the like. In some implementations, a processor of the UE (e.g., a processor of a modem of the UE) may be configured to identify a setting associated with a SIM within the UE that indicates whether that SIM is selected as a DDS SIM. In some implementations, a processor of the UE may determine when a SIM is selected and/or designated as a DDS SIM and/or determine how long that SIM has been selected and/or designated as a DDS SIM. In some implementations, a processor of the UE may monitor amount of data usage (e.g., amount of data transmitted and/or received) per one or more time periods via a SIM. In some implementations, a processor of the UE may be configured to identify when the most recent or last voice call is placed using the SIM and determine how long it has been since that call. Similarly a processor of the UE may be configured to identify when the most recent or last emergency call is placed using the SIM and determine how long it has been since that emergency call. In some implementations, 502 may be performed by metric component 740.

At 504, the UE determine whether the SIM is primarily used for data, based on the one or more metrics. In some implementations, a processor of the UE may be configured to compare the one or more obtained metrics or values associated with the usage parameters for a SIM with threshold values of the corresponding usage parameters. In some implementations, a processor of the UE may determine that the one or more obtained metrics or values satisfy the corresponding threshold values, and in response the processor of the UE determines that the SIM is primarily used for data. In some implementations, 504 may be performed by determination component 742. Finally, at 506, the UE may configure the SIM to be data-centric based on determining that the is primarily used for data. In some implementations, a processor of the UE may configure and/or designate the SIM to be data-centric by autonomously switching a setting associated with the SIM to a data-centric setting or a predetermined value that indicates that the SIM is data-centric. In some implementations, the usage setting of the SIM may be predetermined and/or pre-selected to indicated that the SIM is voice-centric, where voice and/or voice service(s) is prioritized over data and/or data service(s), and a UE may configure and/or designate the SIM to be data-centric by autonomously switching the usage setting as described above. In some implementations, 506 may be performed by component 744.

In some implementations, a usage parameter of the one or more usage parameters is a DDS and a first metric of the one or more metrics associated with the usage parameter indicates whether the SIM is designated as a DDS. In some implementations, a second metric of the one or more metrics associated with the usage parameter indicates a length of time for which the SIM has been designated as the DDS. The UE may determine whether the second metric satisfies a threshold length of time for which the SIM has been designated as the DDS. The UE may determine that the SIM is primarily used for data in response to determining that the second metric satisfies the threshold length of time.

In some implementations, a usage parameter of the one or more usage parameters is related to voice calls placed on a subscription (e.g., a subscription associated with a SIM, or on a SIM, via a SIM, and/or using a SIM), and a metric of the one or more metrics indicates a time at which a last voice call was placed on a subscription (e.g., a subscription associated with a SIM, on a SIM, via a SIM, or via the SIM. The UE may determine whether the metric satisfies a threshold time at which the last voice call was placed. In response to determining that the metric satisfies the threshold time, the UE may determine that the SIM is primarily used for data.

In some implementations, a usage parameter of the one or more usage parameters is data usage, and a metric of the one or more metrics associated with the usage parameter indicates an amount of data usage on the SIM during a time period. The UE may determine whether the metric satisfies a threshold data usage amount. In response to determining that the metric satisfies the threshold data usage, the UE may determine that the SIM is primarily used for data.

In some implementations, a usage parameter of the one or more usage parameters indicates a user preference and a metric associated with the usage parameter indicates whether the user preference for the SIM is data centric. The UE may determine whether the metric indicates that the user preference for the SIM is data centric. In response to determining that the metric indicates that the user preference for the SIM is data centric, the UE may determine that the SIM is primarily used for data.

The UE may detect a voice-session failure (e.g., an IMS registration failure) of the SIM with a base station. The UE may determine whether the SIM is configured and/or designated as data-centric. The UE may refrain from switching to a different radio access technology (RAT) from a current RAT, in response to determining that the SIM is configured and/or designated as data-centric.

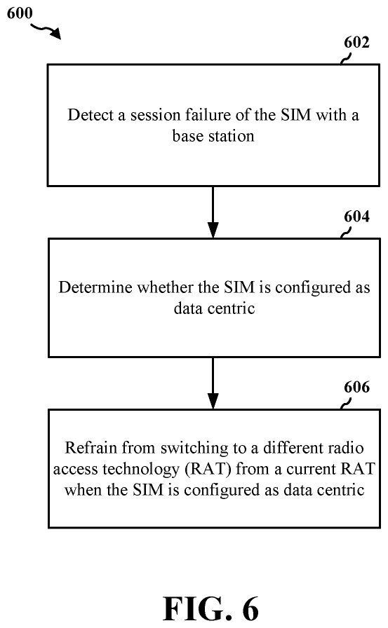

FIG. 6 is a flowchart 600 of a method of wireless communication. The method may be performed by a UE (e.g., the UE 104; the UE 406; the apparatus 702). At 602, the UE may detect a session failure of a SIM with a base station. In some implementations the UE may detect a voice-session failure of a SIM with a base station. For example, the UE may detect an IMS registration failure with a base station. In some implementations, 602 may be performed by session component 746.

At 604, the UE may determine whether the SIM is configured and/or designated as data-centric. In some implementations, a processor of the UE may determine whether the SIM is configured and/or designated as data-centric by checking and/or determining whether a value of a setting associated with the SIM indicates that it is a data-centric SIM or not data-centric (e.g., voice-centric) SIM. In some implementations, 604 may be performed by data centric component 748. At 606, the UE may refrain from switching to a different RAT from a current RAT when the SIM is configured as data-centric. In some implementations, the UE may refrain from switching to a different RAT by remaining camped on the current RAT. For example, 606 may be performed by switching component 750.

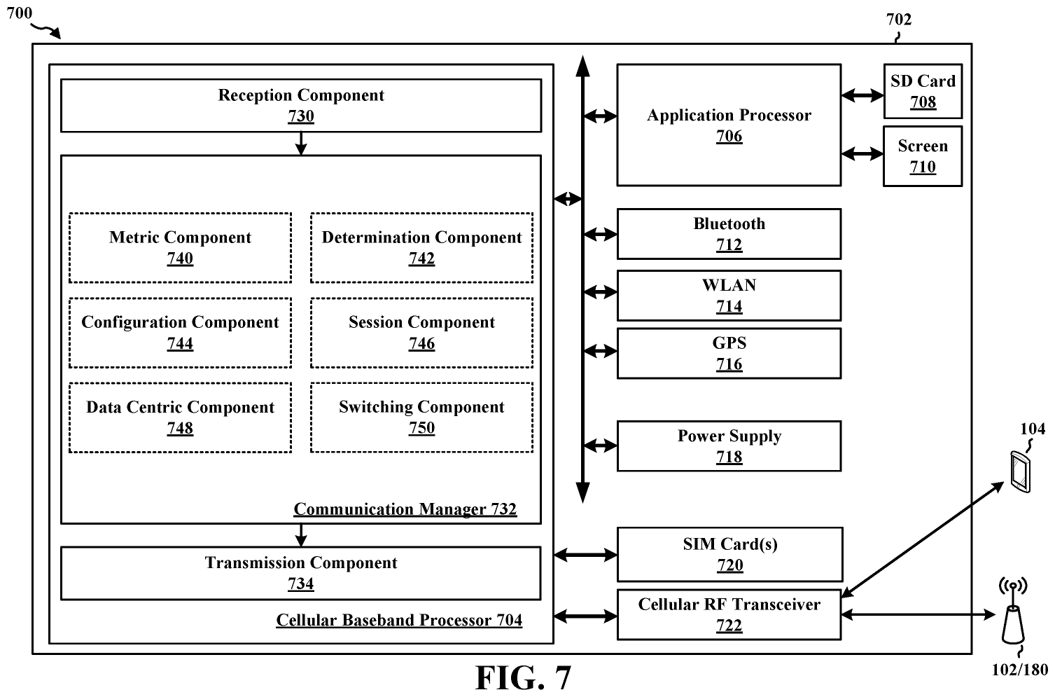

FIG. 7 is a diagram 700 illustrating an example of a hardware implementation for an apparatus 702. The apparatus 702 is a UE and includes a cellular baseband processor 704 (also referred to as a modem) coupled to a cellular RF transceiver 722 and one or more subscriber identity modules (SIM) cards 720, an application processor 706 coupled to a secure digital (SD) card 708 and a screen 710, a Bluetooth module 712, a wireless local area network (WLAN) module 714, a Global Positioning System (GPS) module 716, and a power supply 718. The cellular baseband processor 704 communicates through the cellular RF transceiver 722 with the UE 104 and/or BS 102/180. The cellular baseband processor 704 may include a computer-readable medium/memory. The computer-readable medium/memory may be non-transitory. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704. The cellular baseband processor 704 may be a component of the UE 350 and may include the memory 360 and/or at least one of the TX processor 368, the RX processor 356, and the controller/processor 359. In one configuration, the apparatus 702 may be a modem chip and include just the baseband processor 704, and in another configuration, the apparatus 702 may be the entire UE (e.g., see 350 of FIG. 3) and include the aforediscussed additional modules of the apparatus 702.

The communication manager 732 includes a metric component 740 that is configured to obtain one or more metrics associated with one or more usage parameters of a subscriber identity module (SIM) of the UE, e.g., as described in connection with 502 of FIG. 5. The communication manager 732 further includes a component 742 configured to determine, based on the one or more metrics, whether the SIM is primarily used for data, e.g., as described in connection with 504 of FIG. 5. The communication manager 732 further includes a configuration component 744 configured to configure the SIM to be data centric when the SIM is primarily used for data, e.g., as described in connection with 506 of FIG. 5. The communication manager 732 further includes a session component 746 configured to detect a session failure of the SIM with a base station, e.g., as described in connection with 602 of FIG. 6. The communication manager 632 further includes a data centric component 648 configured to determine whether the SIM is configured as data centric, e.g., as described in connection with 604 of FIG. 6. The communication manager 632 further includes a switching component 650 configured to refrain from switching to a radio access technology (RAT) with a lower data throughput than a current RAT in response to determining that the SIM is configured as data centric, e.g., as described in connection with 606 of FIG. 6.

The apparatus may include additional components that perform each of the blocks of the algorithm in the aforementioned flowcharts of FIGS. 5-6. As such, each block in the aforementioned flowcharts of FIGS. 5-6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for obtaining one or more metrics associated with one or more usage parameters of a subscriber identity module (SIM) of the UE, means for determining, based on the one or more metrics, whether the SIM is primarily used for data, means for configuring the SIM to be data centric in response to determining that the is primarily used for data, means for detecting a session failure of the SIM with a base station, means for determining whether the SIM is configured as data centric, means for refraining from switching to a radio access technology (RAT) with a lower data throughput than a current RAT in response to determining that the SIM is configured as data centric. The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
obtaining one or more metrics associated with one or more usage parameters of a subscriber identity module (SIM) of the UE;
determining, based on the one or more metrics, whether the SIM is primarily used for data; and
configuring the SIM to be data-centric based on determining that the SIM is primarily used for data.

2. The method of claim 1, wherein configuring the SIM to be data centric further comprises:
autonomously switching a usage setting associated with the SIM to data centric setting.

3. The method of claim 1, wherein a usage parameter of the one or more usage parameters is a Default Data Subscription (DDS) and a first metric of the one or more metrics associated with the usage parameter indicates whether the SIM is designated as a DDS.

4. The method of claim 3, wherein a second metric of the one or more metrics associated with the usage parameter indicates a length of time for which the SIM has been designated as the DDS, and determining whether the SIM is primarily used for data further comprises:
determining that the SIM is primarily used for data based on determining that the second metric satisfies a threshold length of time for which the SIM has been designated as the DDS.

5. The method of claim 1, wherein a usage parameter of the one or more usage parameters is related to voice calls placed on the SIM, and a metric of the one or more metrics indicates a time at which a last voice call was placed on the SIM.

6. The method of claim 5, wherein determining whether the SIM is primarily used for data further comprises:
determining that the SIM is primarily used for data based on determining that the metric satisfies a threshold time at which the last voice call was placed.

7. The method of claim 1, wherein a usage parameter of the one or more usage parameters is data usage, and a metric of the one or more metrics associated with the usage parameter indicates an amount of data usage on the SIM during a time period.

8. The method of claim 7, wherein determining whether the SIM is primarily used for data further comprises:
determining whether the metric satisfies a threshold data usage amount; and
in response to determining that the metric satisfies the threshold data usage, determining that the SIM is primarily used for data.

9. The method of claim 1, wherein a usage parameter of the one or more usage parameters indicates a user preference and a metric associated with the usage parameter indicates whether the user preference for the SIM is data centric, and determining whether the SIM is primarily used for data further comprises:
in response to determining that the metric indicates that the user preference for the SIM is data centric, determining that the SIM is primarily used for data.

10. The method of claim 1, further comprising:
detecting a voice session failure of the SIM with a base station;
determining whether the SIM is configured as data centric; and
in response to determining that the SIM is configured as data centric, refraining from switching to a radio access technology (RAT) with a lower data throughput than a current RAT.

11. An apparatus for wireless communication of a user equipment (UE), comprising:
a memory; and
at least one processor coupled to the memory and configured to:
obtain one or more metrics associated with one or more usage parameters of a subscriber identity module (SIM) of the UE;
determine, based on the one or more metrics, whether the SIM is primarily used for data; and
configure the SIM to be data centric based on whether the SIM is determined to be primarily used for data.

12. The apparatus of claim 11, wherein the at least one processor is configured to configure the SIM to be data centric by:
autonomously switching a usage setting associated with the SIM to data centric setting.

13. The apparatus of claim 11, wherein a usage parameter of the one or more usage parameters is a Default Data Subscription (DDS) and a first metric of the one or more metrics associated with the usage parameter indicates whether the SIM is designated as a DDS.

14. The apparatus of claim 13, wherein a second metric of the one or more metrics associated with the usage parameter indicates a length of time for which the SIM has been designated as the DDS, and the at least one processor is configured to determine whether the SIM is primarily used for data by:
determining that the SIM is primarily used for data based on determining that the second metric satisfies a threshold length of time for which the SIM has been designated as the DDS.

15. The apparatus of claim 11, wherein a usage parameter of the one or more usage parameters is related to voice calls placed on the SIM, and a metric of the one or more metrics indicates a time at which a last voice call was placed on the SIM.

16. The apparatus of claim 15, wherein the at least one processor is configured to determine whether the SIM is primarily used for data by:
determining that the SIM is primarily used for data based on determining that the metric satisfies a threshold time at which the last voice call was placed.

17. The apparatus of claim 11, wherein a usage parameter of the one or more usage parameters is data usage, and a metric of the one or more metrics associated with the usage parameter indicates an amount of data usage on the SIM during a time period.

18. The apparatus of claim 17, wherein the at least one processor is configured to determine whether the SIM is primarily used for data by:
determining whether the metric satisfies a threshold data usage amount; and
in response to determining that the metric satisfies the threshold data usage, determining that the SIM is primarily used for data.

19. The apparatus of claim 11, wherein a usage parameter of the one or more usage parameters indicates a user preference and a metric associated with the usage parameter indicates whether the user preference for the SIM is data centric, and the at least one processor is configured to determine whether the SIM is primarily used for data by:
in response to determining that the metric indicates that the user preference for the SIM is data centric, determining that the SIM is primarily used for data.

20. The apparatus of claim 11, the at least one processor is configured to:
detect a voice session failure of the SIM with a base station;
determine whether the SIM is configured as data centric; and
when the SIM is configured as data centric, refrain from switching to a radio access technology (RAT) with a lower data throughput than a current RAT.

21. An apparatus for wireless communication of a user equipment (UE), comprising:
means for obtaining one or more metrics associated with one or more usage parameters of a subscriber identity module (SIM) of the UE;
means for determining, based on the one or more metrics, whether the SIM is primarily used for data; and
means for configuring the SIM to be data centric based on determining that the SIM is primarily used for data.

22. The apparatus of claim 21, further comprising:
means for autonomously switching a usage setting associated with the SIM to data centric setting.

23. The apparatus of claim 21, wherein a usage parameter of the one or more usage parameters is a Default Data Subscription (DDS) and a first metric of the one or more metrics associated with the usage parameter indicates whether the SIM is designated as a DDS.

24. The apparatus of claim 23, wherein a second metric of the one or more metrics associated with the usage parameter indicates a length of time for which the SIM has been designated as the DDS, and the means for determining whether the SIM is primarily used for data further comprises:
determine whether the second metric satisfies a threshold length of time for which the SIM has been designated as the DDS; and
means for determining that the SIM is primarily used for data based on the second metric satisfying a threshold length of time for which the SIM has been designated as the DDS.

25. The apparatus of claim 21, wherein a usage parameter of the one or more usage parameters is related to voice calls placed on the SIM, and a metric of the one or more metrics indicates a time at which a last voice call was placed on the SIM.

26. The apparatus of claim 25, wherein the means for determining whether the SIM is primarily used for data further comprises:
means for determining that the SIM is primarily used for data based on determining that the metric satisfies a threshold time at which the last voice call was placed.

27. The apparatus of claim 21, wherein a usage parameter of the one or more usage parameters is data usage, and a metric of the one or more metrics associated with the usage parameter indicates an amount of data usage on the SIM during a time period, and the means for determining whether the SIM is primarily used for data further comprises:
means for determining whether the metric satisfies a threshold data usage amount; and
means for determining that the SIM is primarily used for data based on determining that the metric satisfies the threshold data usage amount.

28. The apparatus of claim 21, wherein a usage parameter of the one or more usage parameters indicates a user preference and a metric associated with the usage parameter indicates whether the user preference for the SIM is data centric, and the means for determining whether the SIM is primarily used for data is configured to:
means for determining that the SIM is primarily used for data based on the metric indicates that the user preference for the SIM is data centric.

29. The apparatus of claim 21, further comprising:
means for detecting a voice session failure of the SIM with a base station;
means for determining whether the SIM is configured as data centric; and
means for refraining from switching to a radio access technology (RAT) with a lower data throughput than a current RAT based on determining that the SIM is configured as data centric.

30. The apparatus of claim 21, wherein a usage parameter of the one or more usage parameters is data usage, and a metric of the one or more metrics associated with the usage parameter indicates an amount of data usage on the SIM during a time period.
